(19) United States
(12) Patent Application Publication
(10) Pub. No.: US 2026/0111075 A1
(43) Pub. Date: Apr. 23, 2026

(54) PRESENTATION DEVICE FOR REDUCING STRESS AND ANXIETY AND RELATED SYSTEMS AND METHODS

(71) Applicant: Erik Dominguez, Ankeny, IA (US)

(72) Inventor: Erik Dominguez, Ankeny, IA (US)

(21) Appl. No.: 19/361,602

(22) Filed: Oct. 17, 2025

Related U.S. Application Data
(60) Provisional application No. 63/708,519, filed on Oct. 17, 2024.
(60) Provisional application No. 63/781,665, filed on Apr. 1, 2025.

(51) Int. Cl. G06F 3/02; A61H 39/04

(52) U.S. Cl. CPC G06F 3/0202; A61H 39/04; A61H 2201/0153

(57) ABSTRACT

The various implementations contained within this disclosure are directed to a presentation device and associated methods and systems that allow for a speaker to relieve stress and anxiety by fidgeting with one or more features while simultaneously controlling a slideshow and/or using a laser pointer with the same presentation device.

### CROSS-REFERENCES & RELATED APPLICATIONS

This application claims the benefit under 35 U.S. C. § 119(e) to U.S. Provisional Application No. 63/708,519 filed Oct. 17, 2024, entitled “PRESENTATION DEVICE FOR REDUCING STRESS AND ANXIETY,” and U.S. Provisional Application No. 63/781,665, filed Apr. 1, 2025, entitled “PRESENTATION DEVICE FOR REDUCING STRESS AND ANXIETY AND RELATED SYSTEMS AND METHODS,” which are both hereby incorporated by reference in their entirety for all purposes.

### TECHNICAL FIELD

The disclosure relates to presentation devices and the associated systems and methods of use.

### BACKGROUND

Public speaking is a common fear. Additionally, practice does not necessarily ease the nerves of the speaker during the public speaking event. An anxious person, such as a public speaker, may find relief or reassurance by fidgeting in some manner. Various devices and curios have been designed specifically to be fidgeted with. However, the use of the fidgeting devices in front of an audience may be distracting or unprofessional. There is a need in the art for a device, method, or system to allow public speakers or other people in stressful scenarios to relieve anxiety while minimizing the distracting or unprofessional image of using a fidget device.

### BRIEF SUMMARY OF THE INVENTION

The various implementations contained within this disclosure are directed to a device, and associated methods and systems, that allows for a speaker to relieve stress and anxiety by fidgeting with one or more features while simultaneously controlling a slideshow and/or using a laser pointer simultaneously. Various implementations may integrate features to relieve stress and anxiety with features to control a slideshow and/or use a laser point into a single device. Various other implementations may allow features to relieve stress and anxiety to be introduced to a preexisting device that already possesses control features.

A system of one or more computers or computing devices may be configured to perform particular operations or actions by virtue of having software, firmware, hardware, or a combination of them installed on the system that in operation causes or cause the system to perform the actions. One or more computer programs may be configured to perform particular operations or actions by virtue of including instructions that, when executed by data processing apparatus, cause the apparatus to perform the actions.
Example 1 relates to a presentation device for controlling a slideshow comprising: a) at least one control feature; and b) at least one fidget feature.
Example 2 relates to Examples 1 and 3-9, wherein the at least one control feature is selected from the group consisting of: internal circuitry, one or more batteries, one or more removable battery doors, one or more power switches, one or more removable USB receivers, one or more battery power indicators, one or more slide forward buttons, one or more slide back buttons, one or more launch slide show buttons, one or more black screen buttons, one or more lasers, and one or more laser pointer buttons.
Example 3 relates to Examples 1-2 and 4-9, wherein the at least one fidget feature is selected from the group consisting of: one or more toggle switches, one or more calm strips, one or more stimulus joysticks, one or more stimulus tactile buttons, one or more stimulus roller buttons, and one or more acupressure features.
Example 4 relates to Examples 1-3 and 5-9, wherein the presentation device is configured to connect to a computer by establishing electronic communication between the presentation device and the computer.
Example 5 relates to Examples 1-4 and 6-9, wherein the electronic communication is wireless.
Example 6 relates to Examples 1-5 and 7-9, wherein the wireless electronic communication is established with a Bluetooth wireless connection.
Example 7 relates to Examples 1-6 and 8-9, wherein the wireless electronic communication is established with a Wi-Fi wireless connection.
Example 8 relates to Examples 1-7 and 9, wherein the electronic communication is wired.
Example 9 relates to Examples 1-8, wherein the wired electronic communication is established through a USB port.
Example 10 relates to a presentation device for controlling a slideshow comprising: a) internal circuitry configured to send commands to a computer; and b) at least one fidget feature.
Example 11 relates to Examples 10 and 12-17, wherein the at least one fidget feature is one or more toggle switches.
Example 12 relates to Examples 10-11 and 13-17, wherein the at least one fidget feature is one or more calm strips.
Example 13 relates to Examples 10-12 and 14-17, wherein the at least one fidget feature is one or more stimulus joysticks.
Example 14 relates to Examples 10-13 and 15-17, wherein the at least one fidget feature is one or more stimulus tactile buttons.
Example 15 relates to Examples 10-14 and 16-17, wherein the at least one fidget feature is one or more stimulus roller buttons.
Example 16 relates to Examples 10-15 and 17, wherein the at least one fidget feature is one or more acupressure features.
Example 17 relates to Examples 10-16, wherein the one or more acupressure features are affixed to a body of the presentation device in an about linear fashion.
Example 18 relates to a system for controlling a slideshow comprising: a) a computer configured to display a slideshow; b) a presentation device configured to send output commands to the computer, the presentation device comprising: i) at least one control feature; and ii) at least one fidget feature.
Example 19 relates to Examples 18 and 20, wherein the at least one fidget feature is selected from the group consisting of: one or more toggle switches, one or more calm strips, one or more stimulus joysticks, one or more stimulus tactile buttons, one or more stimulus roller buttons, and one or more acupressure features.
Example 20 relates to Examples 18 and 19, wherein the presentation device sends output commands to the computer via a wireless connection.

While multiple implementations are disclosed, still other implementations of the disclosure will become apparent to those skilled in the art from the following detailed description, which shows and describes illustrative implementations of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1 is a top view of the fidget device, according to one implementation.

FIG. 2 is a bottom view of the fidget device, according to one implementation.

FIG. 3 is a side view of the fidget device, according to one implementation.

FIG. 4 is a side view of the fidget device, according to one implementation.

### DETAILED DESCRIPTION

Various implementations in this disclosure may integrate fidget features, discussed in detail below, into a device with control features, likewise discussed in detail below, such that a single device contains features for stress-relief and features for controlling aspects of a relevant electronic device. Various other implementations may allow for the fidget features to be introduced to a preexisting device such as through the use of an exterior sleeve possessing fidget features. The exterior sleeve may be flexible to allow the sleeve to stretch over and be secured to a preexisting device.

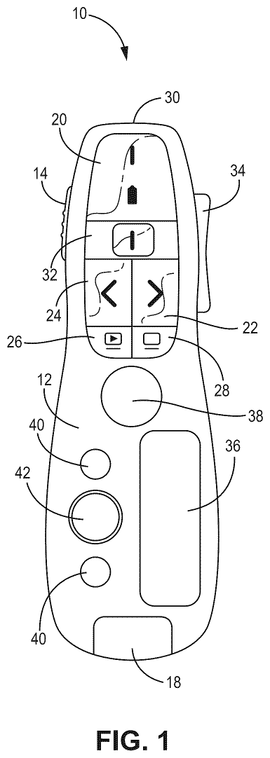

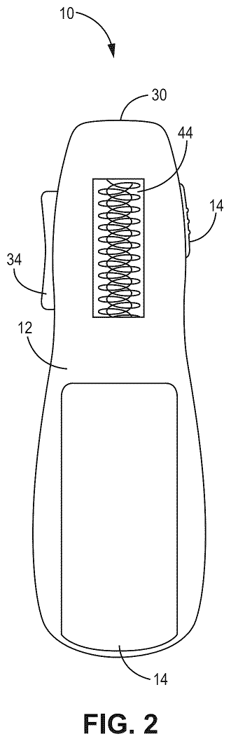

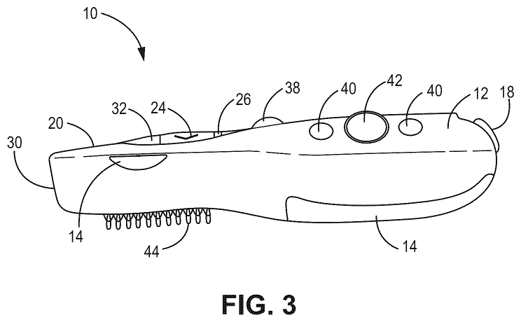

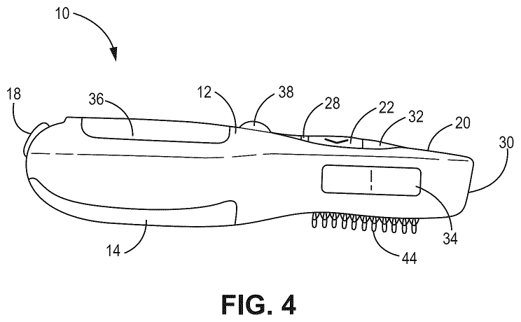

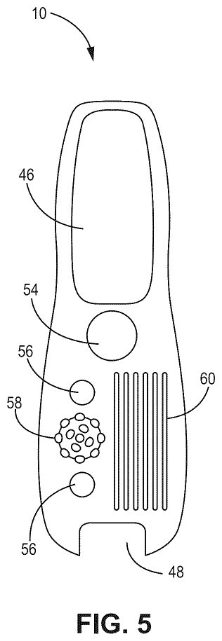

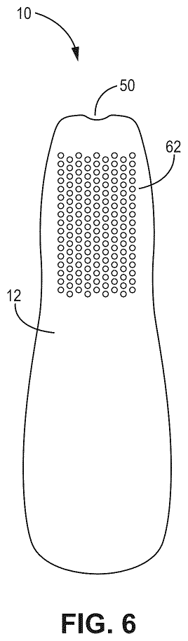

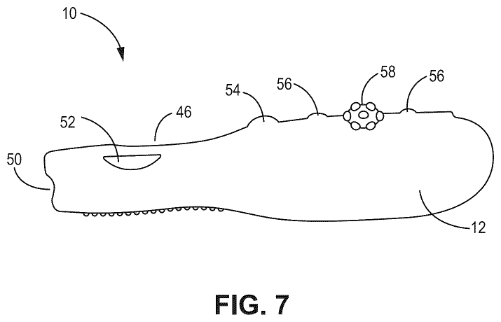

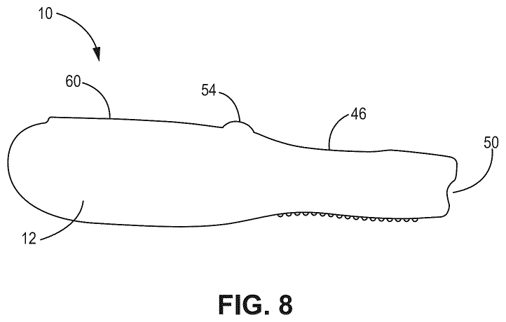

In various implementations, such as shown in FIGS. 1-4, a push button fidget device 10, also called a fidget device 10 or device 10, may have a body 12 with several features. In some implementations, the body 12 may be shaped and sized in order to conform comfortably to the hand of a user. In certain implementations, the body 12 may be a rigid body, such as made of plastic, metal, or a similar material. In other implementations, the body 12 may be made of a flexible material, as will be discussed in more detail below. In some implementations, the body 12 may take various other shapes. As will be discussed in detail below, the features disposed on the body 12 may be control features or fidget features.

In various implementations, the fidget device 10 may have internal circuitry (not shown) to allow the fidget device 10 to operate as a remote for controlling a software-enabled device, such as a computer. In some implementations, the internal circuitry may be powered by a battery (not shown) or similar device configured to supply electricity. The battery may be rechargeable, replaceable, or both. The internal circuitry and battery may be stored, either fully or partially, within the body 12. In various implementations, the battery and/or the internal circuitry may be accessed through a removable battery door 14 disposed on the body 12.

In some implementations, the internal circuitry may be activated by the actuation of a power switch 16, disposed on the body 12. As would be understood, activation of the internal circuitry may be the completion of an electrical circuit between the internal circuitry and the battery, such that the internal circuitry is energized and capable of receiving inputs, sending outputs, and performing relevant computations.

The fidget device 10, in various implementations, may be configured to interface with a computer that is displaying a slideshow. The interaction between the fidget device 10 and the computer may be accomplished through various technologies, such as with a Bluetooth short-range wireless connection, a Wi-Fi wireless connection, or other similar wireless connection technologies. As would be understood, the internal circuitry of the fidget device 10 would be configured to allow for this connectivity through the inclusion of relevant Bluetooth module, Wi-Fi module, or the like in the internal circuitry. In some implementations, such as are shown in FIGS. 1-4, the fidget device 10 may have a removable USB receiver 18 that may be removed from the fidget device 10 and inserted into a USB port of a computer. As would be understood, the insertion of the removable USB receiver 18 may automatically install all required drivers onto the computer to allow the fidget device 10 to interface with the computer seamlessly.

In some implementations, the fidget device 10 may allow for a wired connection to a computer, such as through a USB cord. In some implementations, a port to allow for a wired connection, as well as to allow for charging of the battery, may be disposed on the body.

In various implementations, the fidget device 10, once in electronic communication with a computer, may be configured to send outputs to that computer, which may be received and acted upon by the computer.

In various implementations, the fidget device 10 may have a battery power indicator 20 disposed on the body 12. The battery power indicator 20 may be any device capable of displaying information about the charge level of the battery. The battery power indicator 20 may be an LED screen with a charge level icon or graphic displayed, a liquid crystal display with charge level indicated by liquid crystal bars, one or more lights with battery charge indicated by light intensity or color, or any other device or system capable of displaying battery charge information.

As would be understood, the advancement or regression of the slides contained in the slideshow may be necessary. In various implementations, the fidget device 10 may have a slide forward button 22 and a slide back button 24. In implementations in which the fidget device 10 is in electronic communication with a computer, pressing the slide forward button 22 may cause the internal circuitry to send an output command to the computer to advance the slideshow. Similarly, in implementations in which the fidget device 10 is in electronic communication with a computer, pressing the slide back button 24 may cause the internal circuitry to send an output command to the computer to regress the slideshow.

The fidget device 10 may also have a launch slide show button 26 disposed on the body 12. In implementations in which the fidget device 10 is in electronic communication with a computer, pressing the launch slide show button 26 may cause the internal circuitry to send an output command to the computer to begin a slideshow.

The fidget device 10 may also have a black screen button 28 disposed on the body 12. In implementations in which the fidget device 10 is in electronic communication with a computer, pressing the black screen button 28 may cause the internal circuitry to send an output command to the computer to replace any displayed slide with a black screen. As would be understood, this function would be valuable applications in scenarios where a person who is not authorized to receive the displayed information enters the room.

The fidget device 10 may also have a laser 30 and laser pointer button 32 disposed on the body 12. In various implementations, the laser 30 may be a low power laser intended to shine a visible point of light onto an object or screen to draw attention to that point. In various implementations, the laser pointer button 32 may cause the internal circuitry to activate the laser 30.

The above features are control features. That is, the features above and similar features are generally directed to the operation of the fidget device 10 in relation to a computer and slideshow. Specifically, the control features include, but are not limited to, the internal circuitry, the battery, the removable battery door 14, the power switch 16, the removable USB receiver 18, the battery power indicator 20, the slide forward button 22, the slide back button 24, the launch slide show button 26, the black screen button 28, the laser 30, and the laser pointer button 32. The control features may include these listed features as well as any feature primarily intended to affect physical and/or electrical devices used during a presentation. Other implementations of the fidget device 10 may include a play button, a pause button, a stop button, a volume up button, a volume down button, a mute button, one or more directional selection buttons, one or more directional selection joysticks, an enter or OK button, a menu button, or any other similar button known to those in the art.

Discussed in detail below are the fidget features of the fidget device 10.

In various implementations, the fidget device 10 may have at least one toggle switch 34. As would be understood, the toggle switch 34 may be a button that is pivotable around a point in its substantial center. There may be one or more stable positions for the toggle switch 34, such that the toggle switch 34 may be pressed until the toggle switch 34 snaps to a different stable position. Alternatively, the toggle switch 34 may be an infinitely variable position within its range of motion. As would be understood, the actuation of the toggle switch 34 is not to cause a physical result but instead is to decrease the stress and anxiety of the user.

The fidget device 10 may also have at least one calm strip 36. The calm strip 36 may be a textured sticker, strip of textured fabric, patch of textured rubber, or similar portion of textured material intended to relax a user stroking or touching the calm strip 36. As would be understood, the touching, pressing, or the like of the calm strip 36 is not to cause a physical result, but instead is to decrease the stress and anxiety of the user.

In various implementations, the fidget device 10 may also have at least one stimulus joystick 38. The stimulus joystick 38 may be pressed in any direction, and the stimulus joystick 38 will return to its rest position once it is no longer pressed. As would be understood, the actuation of the stimulus joystick 38 is not to cause a physical result but instead is to decrease the stress and anxiety of the user.

In various implementations, the fidget device 10 may also have at least one stimulus tactile button 40. The stimulus tactile button 40 may be pressed in, and the stimulus tactile button 40 will return to its rest position once it is no longer pressed. As would be understood, the actuation of the stimulus tactile button 40 is not to cause a physical result but instead is to decrease the stress and anxiety of the user.

In various implementations, the fidget device 10 may also have at least one stimulus roller button 42. The stimulus roller button 42 may be pressed in, and the stimulus roller button 42 will return to its rest position once it is no longer pressed. Additionally, the stimulus roller button 42 may be rolled and rotated around its center within a socket in which it sits. As would be understood, the actuation of the stimulus roller button 42 is not to cause a physical result but instead is to decrease the stress and anxiety of the user.

The fidget device 10 may also have an acupressure feature 44. The acupressure feature 44 may be a firm, spiral-wound section of material that flexes under firm pressure, providing localized pressure onto the fingers or other piece of anatomy pressed into the acupressure feature 44. In various implementations, the acupressure feature 44 may be made of a flexible metal, a flexible plastic, or any other suitable material known in the art. In various implementations, the acupressure feature 44 may be affixed to the body 12 in an about linear fashion, as shown in FIGS. 1-4. In other implementations, the acupressure feature 44 may be shaped as a ring disposed on the body 12 or any other shape that may be suitable for a particular implementation.

In implementations such as those of FIGS. 5-8, the body 12 may be made of a pliable substrate. In such implementations, the fidget device 10 may have a preexisting presentation device (not shown), and the body 12 may stretch over the preexisting presentation device to combine the fidget features with the control features already present on the preexisting presentation device.

In such implementations, the body 12 may have a button opening 46 to allow for control features of a preexisting presentation device to be accessible through the body 12. The body 12 may have a receiver opening 48 to allow access to a USB receiver of the preexisting presentation device or similar features such as charging ports. The body 12 may also have a laser opening 50 to allow for the laser pointer of the preexisting presentation device to shine through the body 12. The body 12 may also have a power switch opening 52 to allow for the preexisting presentation device to be powered on through the body 12.

In various implementations, the fidget clicker 10 may have various fidget features, which may include one or more depressible domed structures 54, 56, such as large depressible domed structures 54 and one or more small depressible domed structures 56. The large depressible domed structures 54 and small depressible domed structures 56 may be reversibly depressible. In some implementations, the depressible domed structures 54 and small depressible domed structures 56 may have a yielding, viscous texture that may provide tactile and auditory feedback upon actuation. The large depressible domed structures 54 and small depressible domed structures 56, in some implementations, are configured to return to their original shape upon release, enabling repeated engagement for stress relief, sensory stimulation, or entertainment. As would be understood, interaction with the depressible domed structures 54, 56 is not to cause a physical result but instead is to decrease the stress and anxiety of the user.

In various implementations, the fidget device 10 may have various fidget features, which may include one or more nodular protuberances 58. The nodular protuberance 58 may be protrusions from the body 12 with a series of small protrusions on the surface of the nodular protuberance 58. The construction of the nodular protuberance 58, as would be understood, would provide an interesting texture to users. As would be understood, interaction with the nodular protuberance 58 is not to cause a physical result but instead is to decrease the stress and anxiety of the user.

In various implementations, the fidget device 10 may have various fidget features, which may include one or more ridges 60. The ridges 60 may be elongated protrusions from the body 12. The construction of the ridges 60, as would be understood, would provide an interesting texture to users. As would be understood, interaction with the raised ridges 60 is not to cause a physical result but instead is to decrease the stress and anxiety of the user.

In various implementations, the fidget device 10 may have various fidget features, which may include a papillose region 62. The papillose region 62 may be a collection of small protrusions from the body 12, optionally spaced closely together to provide an interesting texture to users. As would be understood, interaction with the papillose region 62 is not to cause a physical result but instead is to decrease the stress and anxiety of the user.

As mentioned above, the recently discussed features are fidget features. That is, the features above and similar features are generally directed to reducing the stress of the user by providing satisfying movement options. Specifically, the fidget features include, but are not limited to, the toggle switch 34, the calm strip 36, the stimulus joystick 38, the stimulus tactile button 40, the stimulus roller button 42, the acupressure feature 44, the large depressible domed structures 54, the small depressible domed structures 56, the nodular protuberance 58, the ridges 60, and the papillose region 62. The fidget features may include these listed features as well as any feature primarily intended to reduce the stress or anxiety of a user through a fidgeting mechanism.

Various implementations may include fidget features that are not discussed above. Such additional fidget features may include: pressable clicker buttons that offer a tactile yet silent response; a worry stone or thumb glide designed for soothing rubbing, which may be smooth, indented, or both; a toggle switch or flip switch that may provide a satisfying back-and-forth switching mechanism; a breathing pad or tactile dome that may offer a raised surface that mimics a calming breathing rhythm when indented, such as by the finger; a bearing ball or roller ball that may glides within its track to provide a smooth, satisfying motion; interlocking fidget gears, spinner gears, or gear trains that may interlock and may rotate smoothly; a spinner dial or rotating disc that may spin smoothly to provide a satisfying feeling to users; a joystick may offer multi-directional tactile sensation; textured strips, which may have some or all of stimulus tactile buttons 40, ridges, and corduroy surfaces; sliding beads, which may slide along tracks or wires; strips of zipper that may provide a satisfying zipping sound and sensation; track sliders, that may be elements slidably disposed in tracks on the device 10; rotating, stackable rings that may be disposed around the device 10; compressible and pliable protrusions, sometimes call pop-it bubbles, that may be satisfyingly indented before returning to their natural shape; snap mechanisms that may be spring loaded elements constructed to snap back to their original position when disturbed and released; combination dials, which may have dials with numbers or symbols, which may be pleasant to actuate; marble maze tracks, which may be sliding or rolling elements enclosed in a maze track; force sensitive plates that may depress under a sufficient force and resist depression under insufficient force; lightweight chains that may be satisfying or interest to the touch; expandible and contractible plastic segments that may provide a satisfying sensation when expanded or contracted, in some implementations the plastic segments may use an accordion-like construction; Velcro patches, which may provide a satisfying scratching sensation or may be satisfying to engage and disengage with a corresponding section of Velcro; elastic fixtures, such as loops, which may provide a satisfying stretching sensation; rotating wheels that may rotate and may also be compressed inward, giving a satisfying click sensation; panels that may slide to reveal sections with different textures underneath, various buttons or levers with spring-resistance when compressed or repositioned; cylinders that may rotate about and axis, providing a satisfying rolling sensation; and various other raised textures that may provide finger or hand stimulation.

Although the disclosure has been described with reference to preferred implementations, those skilled in the art will recognize that changes may be made in form and detail without departing from the spirit and scope of the disclosed apparatus, systems and methods.

What is claimed is:

1. A presentation device for controlling a slideshow comprising:
a) at least one control feature; and
b) at least one fidget feature.

2. The presentation device of claim 1, wherein the at least one control feature is selected from the group consisting of: internal circuitry, one or more batteries, one or more removable battery doors, one or more power switches, one or more removable USB receivers, one or more battery power indicators, one or more slide forward buttons, one or more slide back buttons, one or more launch slide show buttons, one or more black screen buttons, one or more lasers, and one or more laser pointer buttons.

3. The presentation device of claim 1, wherein the at least one fidget feature is selected from the group consisting of: one or more toggle switches, one or more calm strips, one or more stimulus joysticks, one or more stimulus tactile buttons, one or more stimulus roller buttons, and one or more acupressure features.

4. The presentation device of claim 1, wherein the presentation device is configured to connect to a computer by establishing electronic communication between the presentation device and the computer.

5. The presentation device of claim 4, wherein the electronic communication is wireless.

6. The presentation device of claim 5, wherein the wireless electronic communication is established with a Bluetooth wireless connection.

7. The presentation device of claim 5, wherein the wireless electronic communication is established with a Wi-Fi wireless connection.

8. The presentation device of claim 4, wherein the electronic communication is wired.

9. The presentation device of claim 8, wherein the wired electronic communication is established through a USB port.

10. A presentation device comprising:
(a) a body made of a pliable substrate; and
(b) at least one fidget feature.

11. The presentation device of claim 10, wherein the body is configured to fit over a preexisting presentation device.

12. The presentation device of claim 11, wherein the body comprises one or more button openings, the one or more button openings being shaped and positioned to allow buttons of the preexisting presentation device to be accessible when the body is fit over the preexisting presentation device.

13. The presentation device of claim 11, wherein the body comprises one or more laser openings, the one or more laser openings being shaped and positioned to allow a laser or light of the preexisting presentation device to shine outward when the body is fit over the preexisting presentation device.

14. The presentation device of claim 11, wherein the body comprises one or more power switch openings, the one or more power switch openings being shaped and positioned to allow a user to access a power switch of the preexisting presentation device when the body is fit over the preexisting presentation device.

15. The presentation device of claim 10, wherein the at least one fidget feature is one or more toggle switches.

16. The presentation device of claim 10, wherein the at least one fidget feature is one or more calm strips.

17. The presentation device of claim 10, wherein the at least one fidget feature is one or more stimulus joysticks.

18. A system for controlling a slideshow comprising:
a) a computer configured to display a slideshow;
b) a presentation device configured to send output commands to the computer, the presentation device comprising:
i) at least one control feature; and
ii) at least one fidget feature.

19. The system of claim 18, wherein the at least one fidget feature is selected from the group consisting of: one or more toggle switches, one or more calm strips, one or more stimulus joysticks, one or more stimulus tactile buttons, one or more stimulus roller buttons, and one or more acupressure features.

20. The system of claim 18, wherein the presentation device sends output commands to the computer via a wireless connection.
